(19) United States
(12) Patent Application Publication
(10) Pub. No.: US 2009/0184804 A1
(43) Pub. Date: Jul. 23, 2009

(54) METHOD AND APPARATUS FOR MONITORING A BUILDING

(76) Inventor: Heikki Seppa, Helsinki (FI)

Correspondence Address: BIRCH STEWART KOLASCH & BIRCH, PO BOX 747, FALLS CHURCH, VA, 22040-0747, US

(21) Appl. No.: 12/301,450

(22) PCT Filed: May 14, 2007
(86) PCT No.: PCT/FI2007/050272

§ 371 Date: Nov. 18, 2008

(30) Foreign Application Priority Data
May 19, 2006 (FI) 20060493

(51) Int. Cl. H04Q 5/22

(52) U.S. Cl. 340/10.1

(57) ABSTRACT

The invention relates to a method in connection with electrical-energy measurement. According to the method the electrical energy consumption (1) of a building is measured, and the measured data are sent over telecommunications link (2) to the desired party. According to the invention RFID devices (3, 13, 15) are used to produce and read information on the building, an energy meter (1) and its telecommunications links (2) are used to forward the RFID-based building information.

The present invention relates to a method, according to the preamble of claim 1, for monitoring a building.

The invention also relates to an apparatus for monitoring a building.

Devices and methods of this kind are used in homes, condominiums, and shopping centres, when a comprehensive building-monitoring system is required.

Power-network companies are making a transition to automatic meter reading (AMR). However, from the point of view of the network companies, the automation of reading is not sufficient by itself to justify investment in a remote-reading system. It has been proposed that, in connection with remote reading, the reading can be made at even hourly intervals and the quality of the electricity can be monitored. In principle, other properties and fault states of a low-voltage network can be monitored through a remotely readable kWh meter. AMR technology is becoming common and it has been estimated that in the Nordic countries domestic households will switch to the use of AMR within the next 5 years, while in the other EU countries the change will take place slightly more slowly. If and when AMR is based on GPRS data transfer, the data-transfer speed will be sufficient to provide other services too.

RFID technology is one of the world's most rapidly growing sectors of industry. Logistics and production automation are beginning to use UHF frequencies while in ticketing and billing there is a general move to the use of the 13.56-MHz frequency range. Through NFC co-operation, RF-range readers are beginning to appear in mobile telephones and it is forecast that by 2010 mobile phones will also support UHF frequencies. From the point of view of consumers and device manufacturers, the important factor is that in the future cheap RFID transponders (the cheapest are now C= 0.05), circuit series, and readers will be available. Future user interfaces will also be built on an RFID basis.

Automation of the home has been talked about for decades, but there has been no significant breakthrough in this field. PC-based partly wireless systems, separate often GPRS-based access-surveillance and control systems, etc. are, it is true, available. Several different solutions have been produced for monitoring the elderly. All these systems are either technically poor, require a separate infrastructure, or are expensive. In addition, the lack of a single standard has not given consumers confidence to introduce these systems. In automation, a internal autonomic system in the home and a user interface-based system between a domestic appliance and the consumer have remained opposed to each other. Present systems are also hampered by the production of unnecessarily complicated systems, for example, so that the talk is of monitoring the contents of a refrigerator, while matters that are really important to customers, such as faults and deficiencies in the home electrical system, smoke alarms, etc. remain in the background, even though in practice they are considerably more important than comfort solutions.

According to the prior art, RFID modules have been used to transfer data from an energy meter to a reading device.

Building monitoring, in turn, has been implemented with the aid of either wired or wireless sensors, in such a way that the data of the sensors is collected in a central device, from where they are forwarded over telecommunications links to a desired party, particularly in alarm situations. Thus known building-monitoring systems have demanded a separate central unit, as well as sensors that can communicate with it. Such a system is expensive and the installation work both demanding and expensive.

The invention is intended to eliminate the defects of the state of the art disclosed above and for this purpose create an entirely new type of method and apparatus for the monitoring of buildings.

The invention is based on building the system around a remotely-readable energy meter, in such a way that a reading device using RFID or corresponding technology in the energy meter is used to read sensors using RFID or corresponding technology, over the cabling of the electrical network, the data being forwarded using the already existing telecommunications links of the remotely-readable energy meter.

More specifically, the method according to the invention is characterized by what is stated in the characterizing portion of claim 1.

The apparatus according to the invention is, for its part, characterized by what is stated in the characterizing portion of claim 8.

The invention also related to the use of an energy meter.

Considerable advantages are gained with the aid of the invention.

The arrangement according to the invention permits the complete elimination of the central unit that has traditionally been used in building monitoring. Very cheap passive RFID tags, the readability of which will allow power-cable faults, for example, to be detected very simply, can be connected through the cabling of the electricity network. The system also permits complicated sensors or sensor systems to be connected for reading by the energy meter at very low cost. An additional advantage of the system is the ease of installation and cheapness of RFID electronics.

It is easy to integrate in the system additional interfaces, which can be used to bypass the energy meter in the implementation of the reading of sensors, with the aid of a mobile station, for example.

In the following, the invention is examined with the aid of examples and with reference to the accompanying drawings,

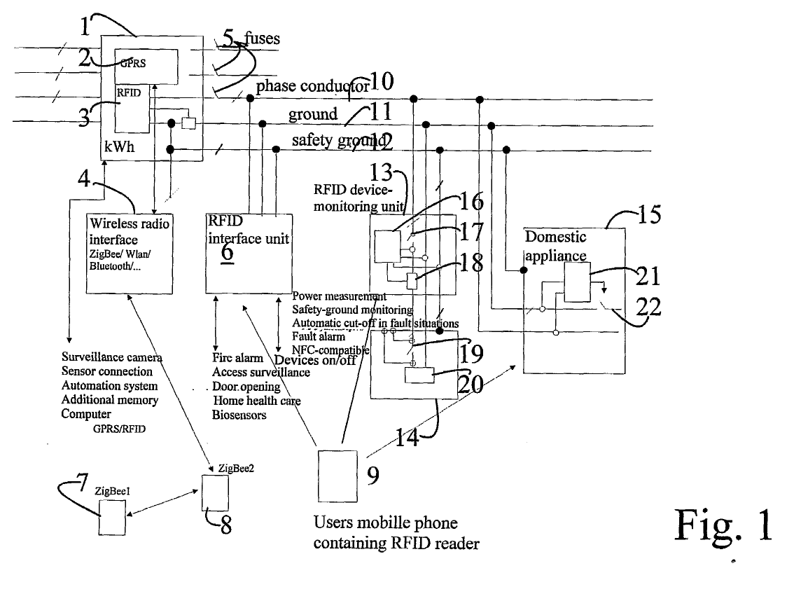

FIG. 1 shows schematically one system according to the invention.

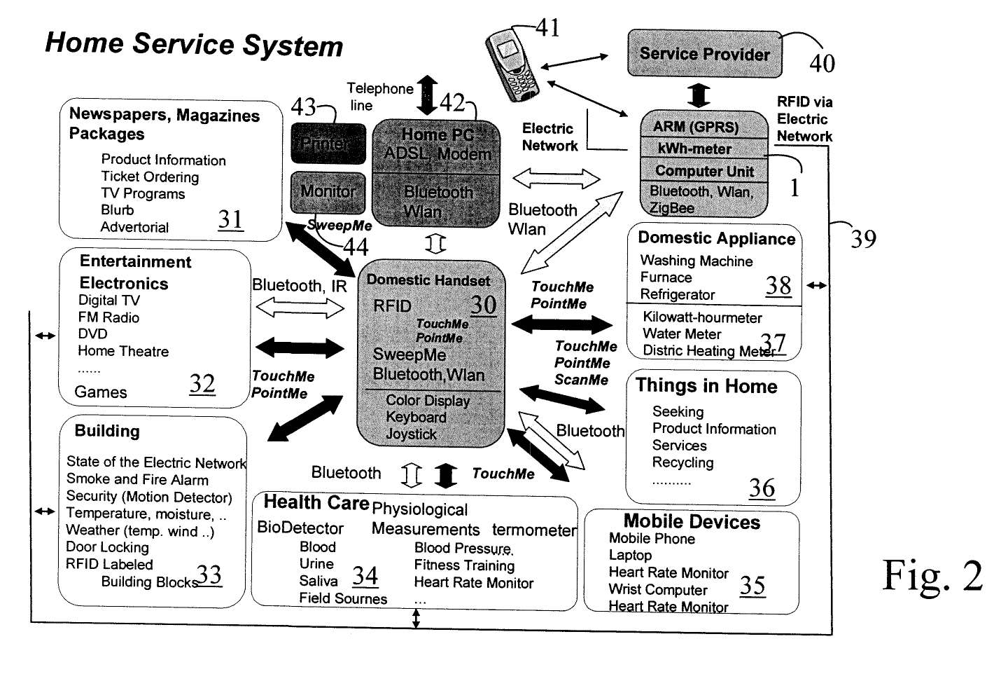

FIG. 2 shows schematically the operation of the system according to the invention.

The applicant's earlier patent application FI-20051244, which is confidential at the moment of filing of the present application, discloses a method, in which by using a mobile telephone and the RFID protocol, it is possible to transmit the measuring and quality data of an energy meter to a power company.

The present invention discloses a method, in which the same technology is utilized to make a building-monitoring system, for example, for monitoring homes and public buildings, with the aid of passive RFID detectors or sensors, among others. The following terminology is used in connection with FIG. 1:
ARM unit 1
Remote reading unit 2
RFID unit 3
Wireless radio interface 4
Fuses 5
RFID interface 6
ZigBee1 7
ZigBee2 8
Mobile station equipped with RFID reader 9
Phase conductor 10
Ground conductor 11
Safety ground 12
RFID monitoring unit 13
Power-measuring and condition-monitoring unit 14
Domestic appliance 15
RFID monitoring unit control means 16
Switch or circuit breaker 17
Power measurement 18
Switch or circuit breaker 19
Appliance connected to wall socket 20
Domestic-appliance RFID control unit 21
Switch or circuit breaker 22
Manual controller 30
Magazines 31
Entertainment electronics 32
Building monitoring 33
Health care 34
Wireless devices 35
Things in home 36
Home meters 37
Domestic appliances 38
RFID transfer channel (electrical power cables) 39
Service provider 40
Mobile telephone 41
Telecommunications links 42
Printer 43
Monitor 44

If one begins to consider home automation from the consumer's point of view, it will be noticed that consumers want, on the one hand, an easy and simple user interface with the home's electrical systems and devices and, on the other hand, the automatic operation of certain basic functions, so that the user need not worry about them other than in a possible fault situation. Most of the complex functions of a domestic appliance, for example, will remain unused, because most consumers are not interested in controlling the domestic appliance, like a computer with too many possibilities.

The present statement of invention presents a solution that provides a basis on a generic level for both an interface between a machine and its user and, on the other hand, for the automatic machine-to-machine detection of fault states, as well as for automatic control operations. The solution also permits part of the monitoring of a building and its devices to be outsourced to a third party, though this is not an essential requirement of the technical solution described here.

The invention is intended to create a system, in which combining RFID technology is combined with an ARM system running to buildings, so as to create a very economical building-automation system, by means of which all monitoring relating to the building can be performed. In addition, the persons in the building receive a connection to the system on their own terminal devices. The final objective is for all wall sockets and devices in the building to come within the sphere of the system. In this way, all the rooms and persons can, if necessary, be connected to an information network very economically.

One central idea of the invention is to use an ARM apparatus with RFID readers as the central unit of the building-monitoring system and as a telecommunications interface with the external world. The ARM apparatus, for its part, uses its RFID reader to communicate through the energy-supply network wiring with cheap RFID tags or control devices. The aforementioned RFID units are connected to the energy-supply network either capacitively or inductively.

FIG. 1 shows a situation, in which a GPRS-based (in the future a 3G or some other reasonably fast cellular data-transfer system) remote-reading system 1 is connected to a kilowatt-hour meter. In addition, we assume that the meter includes an RFID reader (both the frequencies used by the NFC forum and possibly UHF). In this case, the RFID reader 3 connected to the kilowatt-hour meter refers to a circuit, which operates both as a remote detector and a reading device reading other remote detectors. The system developed includes not only the GPRS 2 and the RFID reader 3, but also a separate processor or embedded processor and sufficient memory. The RFID signal is connected to each phase conductor 10 and also, with the aid of a ‘current transformer’, between the ground 11 and the safety conductor 12 (not indispensable). We use filters to prevent the RFID signal from travelling outside the building's electricity system. Such a low-pass or band-reject filter is preferably located in the ARM device on the outer interface of the monitoring system, i.e. as close as possible to the supply network, shown on the upper left-hand edge of FIG. 1. For reasons of simplicity, the system is drawn in the figure as a single-phase system.

It is possible to connect to the system an RFID interface 6, for example, with the aid of which RFID information travelling inside the energy network can be brought, for example, for reading to a mobile station 9 containing an RFID reading device. Correspondingly, the ARM unit 1 can form a wireless radio interface 4, by means of which the ARM apparatus 1 can communicate with systems of the prior art. These technologies include Bluetooth, Wlan, and ZigBee, which are represented by the units 7 and 8 in FIG. 1.

The RFID unit 13 can be connected directly to a wall socket, in which case it connects to the phase 10, ground 11, and safety ground 12 conductors, according to the figure. The state and, e.g., power of the device 14 in the socket can then be measured and, for example, a switch 17 can be used to switch off power in problem or danger situations.

Correspondingly, a domestic appliance 15 can include a direct RFID circuit 21, which can be connected to control a switch 22.

The system can be operated as follows:

Devices such as security cameras can be connected directly to the AMR unit 1, but they have unequivocal RFID identifier information. A wireless connection 4 can be connected to the ARM unit 1, in which, for example, the buildings internal ZigBee-based automation system 7, 8 can be connected to an external network through the GPRS module 2 of the ARM 1. A wired network can also be connected to the ARM system 1, in order to connect additional devices to the system (memory unit, computer, . . . ).

An RFID identifier or monitoring unit 14 is connected to the wall sockets of the network, between the phase 10, ground 11, and safety ground 12 and the ground. With the aid of the system, each wall socket becomes part of the network, but its location in the network is not detected without separate information. This information can be transferred to the RFID reader (mobile telephone) 9. This can be done in such a way that the kitchen's identifier, for example, is written into the RFID circuit 13, or the reader 9 is used to make contact with a remote detector for this purpose, and the information is transferred to the RFID detector of the wall socket, or directly to the memory of the meter. A break in the phase conductor 10 or the ground conductor 11 will appear in the second reading of the RFID detector being prevented. A break in the ground conductor 11 and/or the phase conductor 10 will appear as a break in the second phase conductor. The accuracy of the system is can be further determined by the amount of power used to detect the RFID. Combining in the socket RFID signals connected suitably via two routes makes it possible to detect faults by only one RFID identifier. If an antenna is connected to the RFID circuit in the socket, the operation of the RFID circuit and the supply of electricity to this socket can be checked also by using a separate RFID reader (mobile telephone) 9. If two RFID circuits are connected to the socket, a fault state can be registered in the memory of the other RFID circuit. This means that each time a device is connected to the socket, possible damage to the wiring can be checked. By means of a separate arrangement, the AMR unit 1 can also write to the memory of the RFID circuits that electricity has been connected to the supply in question, so that the consumer will not necessarily need a separate voltmeter to receive this information. The RFID connected to the socket can also be replaced with an adapter, which contains RFID detectors, connected to the plug in the socket. This also permits old sockets to be connected to the sphere of the system. It should be noted that the RFID circuit can be connected to the network either inductively, in which case the connection will be proportional to the RF current, or capacitively, in which case the connected field will be proportional to the voltage. This also permits monitoring of whether devices are switched on, because the device loads (generally capacitively) the RF signal. If we use both RF signals and UHF frequencies, further possibilities will be provided for the simple monitoring of the system.

Monitoring of whether doors or windows are closed can be performed in such a way that a separate short circuit or resonance circuit is connected to the RFID circuit, in such a way that, for example, when the door is closed, the resonance frequency, in a 13.56-MHz case, moves to another NFC frequency range, or in such a way that a UHF frequency moves from the 869-MHz range to a new 865-MHz frequency band. Also a water leak in a washing machine, for example, can be detected in such a way that one of the RFID detectors is installed in such a way that if it becomes submerged its operation will be prevented and the ARM device 1 will detect a fault state. With the aid of a change in frequency or a weakening of the connection taking place in an RFID circuit, it is possible to monitor several simple things, such as the exceeding of a temperature limit, the locking of doors and windows, whether a device is switched on (the voltage induced in the network over the RFID circuit is made to depend on whether a device is switched on, at least by adding capacitors and coils to the system), water damage, etc.

A so-called semi-passive remote detector, to which a relay, current measurement and/or power measurement, as well as a sensor (temperature, humidity, . . . ), for example, can also be connected to a socket or separate adapter. This permits, for example, each individual socket to be switched on or off, either through the kWh meter, or directly by telephone. This also permits all the sockets, which have not been intentionally brought into use, to be switched off, to minimize damage. On the other hand, this permits any device whatever to be disconnected from the network through GPRS, either directly using a mobile telephone (RFID) or through the server of the network company. The same properties can also be made to affect the measurement of the current or power travelling through the socket. The use of energy can also be examined directly from the socket by using a mobile telephone, through the kWh meter using a mobile telephone, using GPRS with a mobile telephone, as well as through the network company's server, for example, through the internet.

An RFID detector and antenna is connected to the socket, a separate adapter, or a terminal located at the end of a conductor. With the aid of this, any mobile device whatever in the home can be connected to the system. When operating using RF frequencies, the distance will be reasonably short, but UHF will permit a slightly longer distance. This can be used for controlling the system, for reading data, or for connecting a measuring device (biosensor, blood-pressure sensor, . . . ) through the system to anywhere at all, for example, to a health centre.

A sensor using the RFID protocol is connected to the socket or adapter. The sensor data (temperature, humidity, smoke, . . . ) can be read either directly from the sensor to a mobile telephone, the data can automatically control another device in the system, the sensor data can initiate a fault notification, which is sent by the kwh meter's GPRS directly to the mobile telephone of the owner, the data can be read to the network company's server, from which it initiates an alarm or an operation controlling the system, etc.

In a device using electricity (lamp, domestic appliance, air-conditioning system, . . . ) there is a an RFID detector or a fault detector using the RFID protocol, and a remote detector reading the sensor data or controlling the machine. This can be used as described above, but a connector using the RFID protocol and connected to the machine will permit all the functions of the machine to be monitored directly from the machine to a telephone, using the RFID protocol, using GPRS, or through the internet.

The functions permitted by the system according to the invention are described in the following, with reference to FIG. 2, for instance.

All the sockets and devices installed in the building are automatically identified and alteration work can be seen directly from the system. The location of the socket or device in the building must be entered manually or by using a telephone and TouchMe user interface.

The maximum load of the electrical system can be identified automatically.

With the aid of the system it is possible to implement the detection and monitoring of, among others, the following matters:
Short-circuit to ground, failure of safety ground, and other equipment failures can be detected and monitored
Fuses
Power-on state during alteration work
Position of relays
Smoke and fire alarm
Access surveillance (infrared camera), doors opening, etc.
Moisture damage
Water leak
Temperature monitoring
Power consumption of, and faults in devices

In addition, by means of the system according to the invention it is possible to implement, among others, the following control and monitoring functions:
Switching off electricity and water, either automatically or using a mobile telephone
Switching devices on or off, either automatically or using a mobile telephone
Switching on a computer
Adjusting air-conditioning
Connecting an existing or new wireless system to a global information network
RFID-technology-based access surveillance of the elderly or children
Monitoring of the position or state of health of a person equipped with a sensor
Surveillance of domestic animals

The system can be used in a sensor system in the home in, among others, the following ways:
Home health care
Blood-pressure measurement, measurement and data transfer of blood, saliva, and urine samples
The building's humidity sensors, temperature sensors, carbon-dioxide content, total energy consumption, device-specific energy consumption.

The system can also be used as a user interface with domestic appliances:
RFID cover allows manufacturers to add a www or WAP address to the memory of the RFID, so that the consumer can use a telephone to obtain additional information of the repair of faults in a device or to arrange servicing. Instructions concerning recycling can also be added to the services.
Direct reading of sensor data concerning the device, for example, by touching the device (energy consumption, condition of filters)

The system can also be used in service company operations, for example, as follows:
A network company, or a company with an agreement with a network company can provide services for building owners with the aid of the system, among others, fault monitoring, domestic-appliance monitoring, power-consumption monitoring, burglar and smoke alarms, security-camera surveillance, monitoring of door and window locking, switching electrical appliances on or off, etc.
If the system is connected to a home computer, software companies can develop software for consumers for the monitoring of homes and domestic appliances.

As a summary with reference to FIG. 2, the system according to the invention can, with the aid of a handset 30 combined with a reader, be used to scan individualization data, for example, from newspapers 31 and other printed material. The handset 30 can be used to control, for example, entertainment electronics 31b, with the aid of Bluetooth, an infrared transmission, or an RFID protocol (TouchMe). The same handset 30 can also be used to perform building monitoring 33 or health care 34 and to control wireless devices 35. The handset 30 can also be used to take care of general things in the home 36, such as search for product information, search for goods, or find out about matters relating to recycling, or read the home's meters 37, or control the domestic appliances 38. The electricity-supply network acts as the transfer path 39. The service provider 40 can be in direct contact by means of the ARM device 1 or mobile station 41. Both the ARM device 1 and the handset 30 can be connected to the home PC device and its telecommunications links 42, the home PC being naturally also connected to a printer 43 and monitor 44.

In this application, the term RFID devices refers to both passive RFID tags (RFID detector), which receive their energy purely from the electromagnetic reading energy, and also to active and semi-active tags (detectors).

In this connection, the RFID device can thus be an individual RFID tag.

According to the invention, it is thus possible to implement both a building-monitoring and control system and create a user interface between the appliances and devices in the building and the user of the building.

A preferred embodiment of the invention is the use of the energy-distribution conductors (electricity conductors) as a transfer path. In addition to, or entirely replacing these, it is also possible to use separate conductors as a transfer path.

The system also permits, two-way traffic, in which case, for example, the RFID devices inside devices or appliances can actively forward information. This is a possible mode of operation, for example, in connection with smoke alarms.

1. Method in connection with electrical-energy measurement, in which method
the electrical energy consumption (1) of a building is measured, and
the measured data are sent over telecommunications link (2) to the desired party,
characterized in that
RFID devices (3, 13, 15) are used to produce and read information on the building, which comprises not only energy consumption information, but also information relating to the monitoring and condition of the building, and
an energy meter (1) and its telecommunications links (2) are used to forward the RFID-based building information.

2. Method according to claim 1, characterized in that the energy-distribution conductors are used as the transfer path (39) of the RFID information in the building.

3. Method according to claim 1 or 2, characterized in that at least one RFID device (13) is used, which is a passive RFID detector or sensor connected to an energy-distribution conductor (39) capacitively or galvanically.

4. Method according to claim 1, or 2, or 3, characterized in that the system comprises a connection unit (4, 6) for transferring the RFID information to other systems.

5. Method according to claim 1, 2, 3, or 4, characterized in that in the electrical-energy meter (1) the RFID signal is filtered out, so that it will not spread to other monitoring systems.

6. Method according to any of the above claims, characterized in that the electrical wall sockets are equipped with RFID elements.

7. Method according to any of the above claims, characterized in that the system communicates with the RFID devices (21) of domestic appliances.

8. Apparatus in connection with electrical-energy measurement, which apparatus comprises
measuring means (1) for measuring the electrical-energy consumption of a building, and
telecommunications means (2) for delivering the measured data to a desired party,
characterized in that
the apparatus comprises RFID devices (3, 13, 15) for producing and reading data on the building, which comprise not only energy-consumption information, but also information relating to the monitoring and condition of the building, and
the energy meter (1) and its telecommunications links (2) act as an RFID-based building-information control unit.

9. Apparatus according to claim 8, characterized in that the transfer path of the RFID information in the building is the energy-distribution cabling.

10. Apparatus according to claim 8 or 9, characterized in that the apparatus comprises at least one RFID device (13), which is a passive RFID detector or sensor connected to an energy-distribution conductor (39) capacitively or galvanically.

11. Apparatus according to claim 8, 9, or 10, characterized in that the system comprises a connection unit (4, 6) for transferring the RFID information to other systems.

12. Apparatus according to claim 8, 9, 10, or 11, characterized in that the electrical-energy meter (1) comprises a filter for filtering out the RFID signal, so that it will not spread to other monitoring systems.

13. Apparatus according to any of the above claims, characterized in that the electrical wall sockets are equipped with RFID elements.

14. Apparatus according to any of the above claims, characterized in that the system is arranged to communicate with the RFID devices (21) of domestic appliances.

15. Use of an energy meter (1) as the control and telecommunications unit of a building-monitoring system.
